(19) United States
(12) Patent Application Publication
(10) Pub. No.: US 2013/0107283 A1
(43) Pub. Date: May 2, 2013

(54) IMAGE FORMING APPARATUS

(71) Applicant: OKI DATA CORPORATION, Tokyo (JP)

(72) Inventor: Kenichi FUNATSU, Tokyo (JP)

(73) Assignee: OKI DATA CORPORATION, Tokyo (JP)

(21) Appl. No.: 13/659,255

(22) Filed: Oct. 24, 2012

(30) Foreign Application Priority Data
Oct. 27, 2011 (JP) 2011-236363

(51) Int. Cl. G06K 15/02

(52) U.S. Cl. 358/1.1

(57) ABSTRACT

An image forming apparatus includes an image forming portion for forming an image on a medium; a main body portion; a medium storage portion; a state detection portion for detecting a movement of the medium storage portion from the main body portion; a medium characteristic identifying portion for identifying a characteristic feature of the medium; a medium characteristic recording portion for recording information of the characteristic feature of the medium; and a control portion for controlling an operation of each portion according to the information of the characteristic feature. The control portion controls the medium characteristic identifying portion to identify the characteristic feature of the medium and update the information of the characteristic feature when a power source is changed from an off state to an on state and the state detection portion detects the movement of the medium storage portion from the main body portion.

### BACKGROUND OF THE INVENTION AND RELATED ART STATEMENT

The present invention relates to an image forming apparatus for forming an image on a print medium. More specifically, the present invention relates to an image forming apparatus capable of controlling a printing operation thereof according to information of a characteristic feature of the print medium (for example, a thickness of the print medium, a type of print medium, and the like).

In order to improve image quality, a conventional image forming apparatus may have a function of detecting a characteristic feature of a print medium (for example, a thickness of the print medium, a type of print medium, and the like. Refer to Patent Reference).

Patent Reference: Japanese Patent Publication No. 2008-242020

According to Patent Reference, the conventional image forming apparatus is configured to detect the characteristic feature of the print medium, so that the conventional image forming apparatus sets an optimal condition for an image forming process according to a detection result.

In the conventional image forming apparatus, when a power source is turned off, for example, the print medium stored in a medium storage portion may be replenished or exchanged. In this case, in the conventional image forming apparatus, after the power source is turned off, the medium storage portion is detached from a main body portion of the conventional image forming apparatus. After the print medium is replenished or exchanged, the medium storage portion is attached to the main body portion and the power source is turned on. In the conventional image forming apparatus, when the power source is turned on, the characteristic feature of the print medium is detected, so that the conventional image forming apparatus sets the optimal condition for the image forming process according to the detection result.

In the conventional image forming apparatus, however, even though it is not necessary to replenish or exchange the print medium while the power source is being turned off, every time the power source is turned on, it is necessary to perform the detection process of the characteristic feature of the print medium, and the adjustment process of, for example, a temperature of a fixing portion, according to the detection result. Accordingly, in the conventional image forming apparatus, it takes a long period of time to start the printing operation on the first sheet after the power source is turned on.

In view of the problems described above, an object of the present invention is to provide an image forming apparatus capable of solving the problems of the conventional image forming apparatus. In the present invention, when the medium storage portion is not detached from the main body portion, it is possible to shorten a period of time from when the power source is turned on to when the printing operation is started on the first sheet.

Further objects and advantages of the invention will be apparent from the following description of the invention.

### SUMMARY OF THE INVENTION

In order to attain the objects described above, according to one aspect of the present invention, an image forming apparatus includes an image forming portion for forming an image on a medium; a main body portion for retaining the image forming portion; a medium storage portion arranged to be detachable relative to the main body portion for retaining the medium therein; a state detection portion for detecting a movement of the medium storage portion from the main body portion; a medium characteristic identifying portion for identifying a characteristic feature of the medium in a middle of transportation of the medium; a medium characteristic recording portion for recording information of the characteristic feature of the medium; and a control portion for controlling an operation of each portion according to the information of the characteristic feature of the medium.

According to the one aspect of the present invention, the control portion controls the medium characteristic identifying portion to identify the characteristic feature of the medium and update the information of the characteristic feature of the medium recorded in the medium characteristic recording portion when a power source is changed from an off state to an on state and the state detection portion detects the movement of the medium storage portion from the main body portion.

According to the one aspect of the present invention, when the medium storage portion is not detached from the main body portion, it is possible to shorten a period of time from when the power source is tuned on to when a printing operation is started on the first sheet.

### BRIEF DESCRIPTION OF THE DRAWINGS

FIG. 1 is a schematic sectional view showing a configuration of an image forming apparatus according to a first embodiment of the present invention;

FIG. 2 is a schematic sectional view No. 1 showing a configuration of a medium storage portion and a surrounding portion thereof of the image forming apparatus according to the first embodiment of the present invention;

FIG. 3 is a schematic sectional view No. 2 showing the configuration of the medium storage portion and the surrounding portion thereof of the image forming apparatus according to the first embodiment of the present invention;

FIG. 4 is a schematic sectional view No. 3 showing the configuration of the medium storage portion and the surrounding portion thereof of the image forming apparatus according to the first embodiment of the present invention;

FIG. 5 is a schematic sectional view No. 4 showing the configuration of the medium storage portion and the surrounding portion thereof of the image forming apparatus according to the first embodiment of the present invention;

FIGS. 6(a) and 6(b) are schematic views No. 1 showing an operation of the medium storage portion and the surrounding portion thereof of the image forming apparatus according to the first embodiment of the present invention;

FIG. 7 is a schematic view No. 2 showing the operation of the medium storage portion and the surrounding portion thereof of the image forming apparatus according to the first embodiment of the present invention;

FIG. 8 is a block diagram showing a functional configuration of the image forming apparatus according to the first embodiment of the present invention;

FIG. 9 is a table showing an example of a relationship between a thickness of a print medium and a setting temperature of a fixing portion of the image forming apparatus according to the first embodiment of the present invention;

FIG. 10 is a schematic view showing an operation of a medium thickness sensor of the image forming apparatus according to the first embodiment of the present invention;

FIG. 11 is a graph showing an example of a relationship between the thickness of the print medium and an output frequency of the medium thickness sensor of the image forming apparatus according to the first embodiment of the present invention;

FIG. 12 is a flow chart No. 1 showing an operation of the image forming apparatus according to the first embodiment of the present invention;

FIG. 13 is a flow chart No. 2 showing the operation of the image forming apparatus according to the first embodiment of the present invention;

FIG. 14 is a flow chart No. 3 showing the operation of the image forming apparatus according to the first embodiment of the present invention;

FIG. 15 is a flow chart No. 4 showing the operation of the image forming apparatus according to the first embodiment of the present invention;

FIG. 16 is a flow chart No. 5 showing the operation of the image forming apparatus according to the first embodiment of the present invention;

FIG. 17 is a flow chart No. 1 showing an operation of the image forming apparatus according to a second embodiment of the present invention;

FIG. 18 is a flow chart No. 2 showing the operation of the image forming apparatus according to the second embodiment of the present invention; and

FIG. 19 is a flow chart No. 3 showing the operation of the image forming apparatus according to the second embodiment of the present invention.

### DETAILED DESCRIPTION OF PREFERRED EMBODIMENTS

Hereunder, embodiments of the present invention will be explained with reference to the accompanying drawings. It should be noted that the accompanying drawings are schematically presented to an extent for understanding the present invention, and the present invention is not limited to the embodiments shown in the accompanying drawings. Further, in the accompanying drawings, same components or similar components are designated with same reference numerals, and redundant explanations thereof are omitted.

### First Embodiment

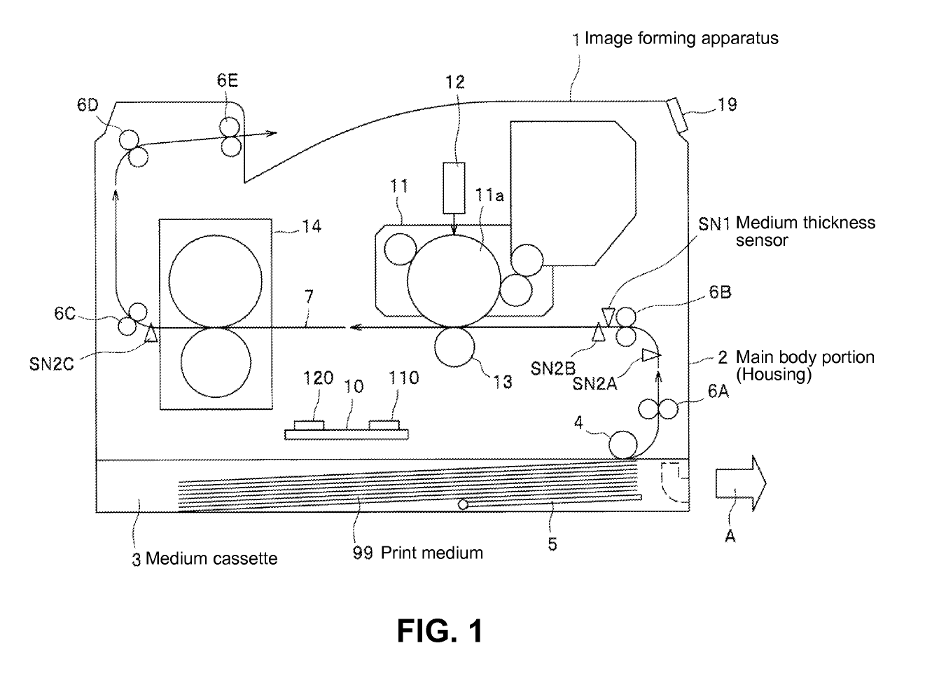

A first embodiment of the present invention will be explained. First, a configuration of an image forming apparatus 1 will be explained with reference to FIG. 1. FIG. 1 is a schematic sectional view showing the configuration of the image forming apparatus 1 according to a first embodiment of the present invention. In the following description, it is supposed that the image forming apparatus 1 is configured as a printer of an electro-photography method.

As shown in FIG. 1, the image forming apparatus 1 includes a main body portion (a housing) 2; a medium cassette 3; a sheet supply roller 4; a medium stage 5; transportation rollers 6A to 6E; a transportation path 7; a control board 10; an image forming portion 11; a print head portion 12; a transfer portion 13; a fixing portion 14; an operator panel 19; a medium thickness sensor SN1; and transportation sensors SN2A to SN2C.

In the embodiment, the main body portion 2 is the housing for retaining main components of the image forming apparatus 1. The medium cassette 3 is a medium storage portion for storing therein a print medium 99 to be used in a printing operation. Further, the medium cassette 3 is configured to be detachable relative to the main body portion 2. For example, when it is necessary to replenish or exchange the print medium 99, the medium cassette 3 is pulled out in an arrow direction A, so that the medium cassette 3 is detached from the main body portion 2. After the print medium 99 is replenished or exchanged, the medium cassette 3 is pushed in an opposite direction to the arrow direction A, so that the medium cassette 3 is attached to the main body portion 2. The sheet supply roller 4 is a medium transportation member for transporting the print medium 99 stored in the medium cassette 3 toward the transportation path 7, so that the print medium 99 is supplied to the image forming apparatus 1.

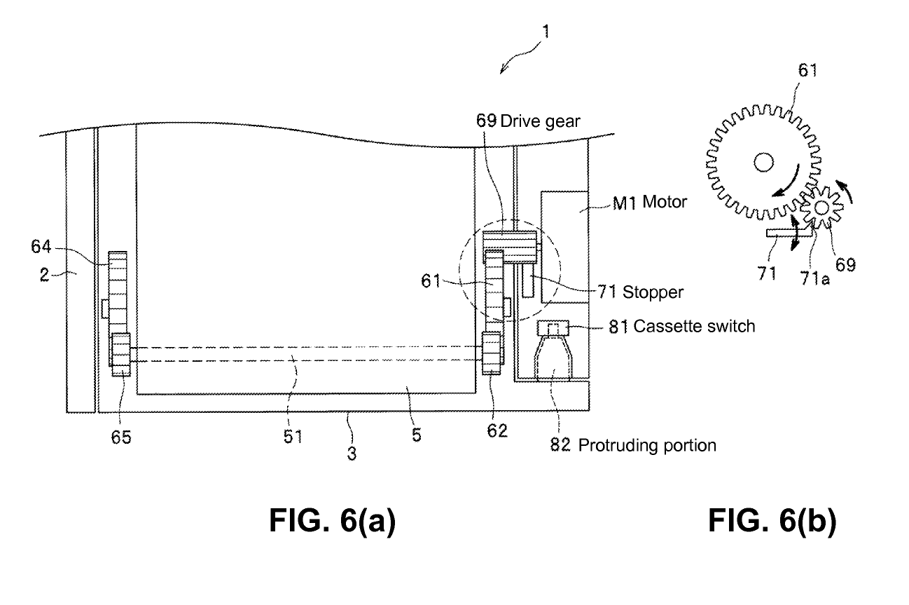

In the embodiment, the medium stage 5 is a supporting member for supporting the print medium 99 such that the print medium 99 is placed on the medium stage 5. When the medium cassette 3 is attached to the main body portion 2, a distal end portion of the medium stage 5 (an end portion of the medium stage 5 facing the sheet supply roller 4) is lifted through a drive force from a motor M1 (described later, refer to FIG. 6(a)), so that the medium stage 5 is inclined. As a result, the medium stage 5 pushes a leading edge of the print medium 99 against the sheet supply roller 4 so that the leading edge of the print medium 99 is pressed against the sheet supply roller 4. When the medium cassette 3 is detached (removed) from the main body portion 2, the distal end portion of the medium stage 5 is lowered, so that the pressing force against the print medium 99 is released and the leading edge of the print medium 99 is separated from the sheet supply roller 4.

In the embodiment, the transportation rollers 6A to 6E are configured as a transportation member so that the print medium 99 is transported along the transportation path 7. A motor (not shown) is provided for driving the transportation rollers 6A to 6E to rotate. The transportation path 7 is a passage through which the print medium 99 is transported. The control board 10 is a board on which a control portion 110 for controlling an operation of each component of the image forming apparatus 1 and a recording portion 120 for recording a control program and data necessary for controlling an operation.

In the embodiment, the image forming portion 11 is a component provided for forming a toner image on a surface of a photosensitive drum 11a disposed therein through the electro-photography process. The print head portion 12 is an exposure unit for partially exposing the surface of the photosensitive drum 11a according to print job data, so that a static latent image is formed on the surface of the photosensitive drum 11a. After the print head portion 12 forms the static latent image on the surface of the photosensitive drum 11a, toner as developer is supplied to the photosensitive drum 11a to form the toner image on the surface thereof.

In the embodiment the transfer portion 13 is formed of a roller for transferring the static latent image formed on the surface of the photosensitive drum 11a to the print medium 99. The fixing portion 14 is a component provided for heating and pressing the toner image transferred to the print medium 99 to melt, so that the toner image is fixed to the print medium 99.

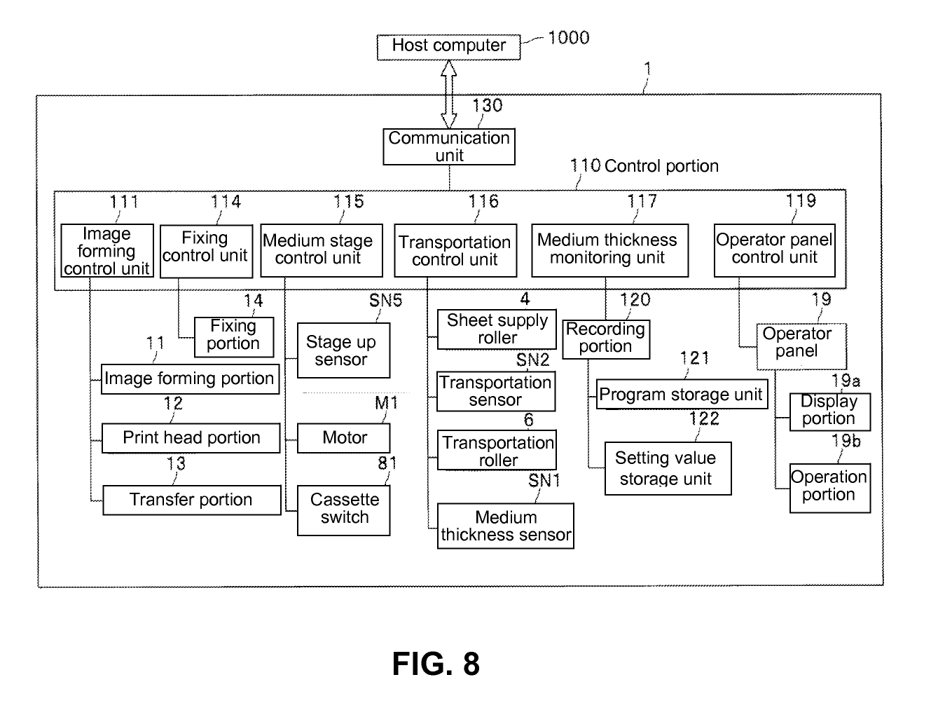

In the embodiment, the operator panel 19 is a component provided for being operated by a user of the image forming apparatus 1. The operator panel 19 includes a display portion 19a for displaying various types of information such as a state of the image forming apparatus 1 and the like and an operation portion 19b as an input portion (refer to FIG. 8) for inputting various types of information necessary for the printing operation.

In the embodiment, the medium thickness sensor SN1 is a detection unit for detecting a thickness of the print medium 99. Further, the transportation sensors SN2A to SN2C are detection units for detecting a transportation state of the print medium 99.

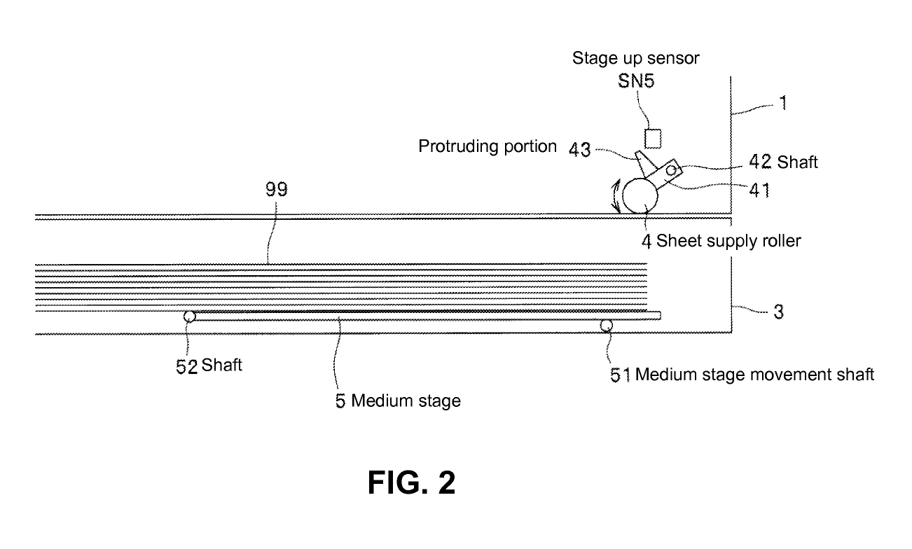

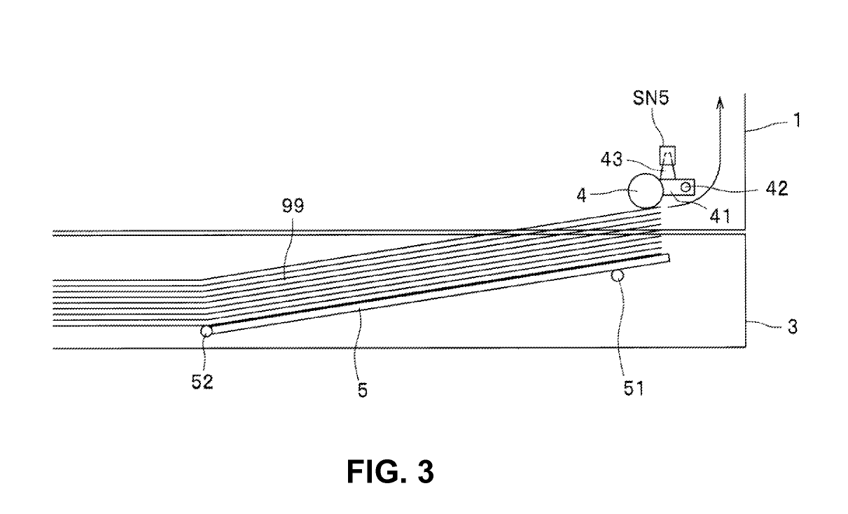

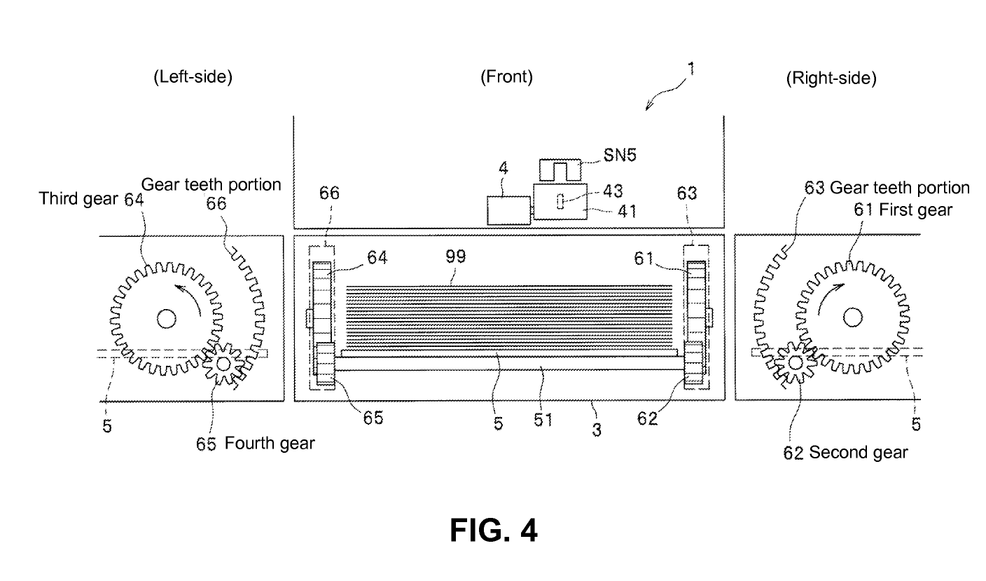

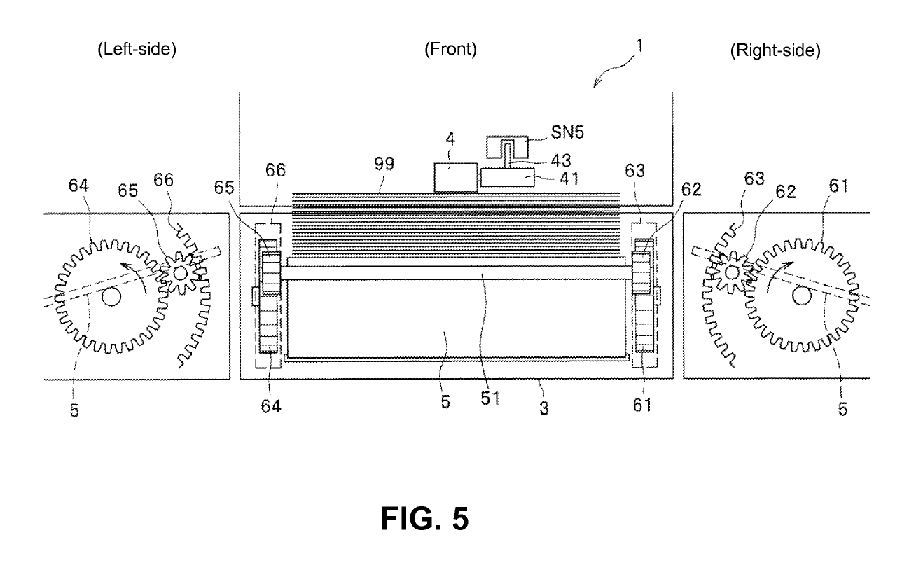

A configuration of the medium cassette 3 and the surrounding portion thereof will be explained next with reference to FIGS. 2 to 5. FIGS. 2 to 5 are schematic sectional views No. 1 to No. 4 showing the configuration of the medium cassette 3 and the surrounding portion thereof of the image forming apparatus 1 according to the first embodiment of the present invention. More specifically, FIGS. 2 and 4 are the schematic sectional views showing the medium cassette 3 and the surrounding portion thereof in a state before the distal end portion of the medium stage 5 is lifted (up), whereas FIGS. 3 and 5 are the schematic sectional views showing the medium cassette 3 and the surrounding portion thereof in a state after the distal end portion of the medium stage 5 is lifted (up).

As shown in FIGS. 2 and 3, the medium cassette 3 includes the medium stage 5, a medium stage movement shaft 51, and a shaft 52. The medium stage movement shaft 51 is a component for moving the distal end portion of the medium stage 5 in an up and down direction. Further, the medium stage movement shaft 51 is arranged to abut against a lower surface of the medium stage movement shaft 51 near the distal end portion. When a motor M1 (refer to FIG. 6(a), described later) is rotated to drive the medium stage movement shaft 51, the medium stage movement shaft 51 is lifted (moves upwardly), so that the distal end portion of the medium stage 5 is lifted. As a result, the medium stage 5 and the print medium 99 placed on the medium stage 5 are changed from the state shown in FIG. 2 to the state shown in FIG. 3.

In the embodiment, the shaft 52 is a rotational axis of the medium stage 5. The shaft 52 is attached to a housing body of the medium cassette 3, so that the shaft 52 supports a rear end portion of the medium stage 5 to be freely rotatable. When the medium stage movement shaft 51 is lifted, the distal end portion of the medium stage 5 is lifted with the shaft 52 as the rotational axis.

In the embodiment, the image forming apparatus 1 further includes a sheet transportation mechanism at an upper portion thereof near the distal end portion of the medium stage 5. The sheet transportation mechanism is formed of the sheet supply roller 4, a supporting portion 41 of the sheet supply roller 4, a protruding portion 43 disposed on the supporting portion 41, and a stage up sensor SN5 as a movement detection portion.

In the embodiment, the supporting portion 41 is a component for supporting the sheet supply roller 4. Further, the supporting portion 41 is formed in a flat plate shape. The supporting portion 41 has one end portion for supporting the sheet supply roller 4 to be freely rotatable and the other end portion connected to the main body portion 2 of the image forming apparatus 1 through a shaft 42 (refer to FIG. 1). Accordingly, the supporting portion 41 is configured to rotate in an arrow direction shown in FIG. 2 with the shaft 42 as the rotational axis. In other words, the one end portion of the supporting portion 41 becomes a free end portion, and the other end portion of the supporting portion 41 becomes a fixed end portion. Further, the rotational axis of the sheet supply roller 4 is attached to a side surface of the other end portion of the supporting portion 41, so that the rotational axis supports the sheet supply roller 4 to be freely rotatable.

In the embodiment, the protruding portion 43 is a component formed in a protruded shape and disposed at a location facing the stage up sensor SN5. The protruding portion 43 is situated at, for example, a substantially central portion of a main front surface of the supporting portion 41 with the flat plate shape.

In the image forming apparatus 1, when the medium cassette 3 is attached to the main body portion 2 and the motor M1 (refer to FIG. 6(a), described later) is rotated and driven, the distal end portion of the medium stage 5 is lifted. Accordingly, a leading edge of the print medium 99 placed on the medium stage 5 is pressed upwardly from below to abut against the sheet supply roller 4, so that the sheet supply roller 4 is lifted. At this moment, the supporting portion 41 of the sheet supply roller 4 is rotated with the shaft 42 as the rotational axis. As a result, the protruding portion 43 disposed on the supporting portion 41 enters a sensor portion (not shown) of the stage up sensor SN5 to block light incident on the stage up sensor SN5. Accordingly, the stage up sensor SN5 becomes an on state, so that it is possible to detect that the distal end portion and the leading edge of the print medium 99 placed on the medium stage 5 are lifted.

In the embodiment, the stage up sensor SN5 is a detection portion for detecting that the distal end portion and the leading edge of the print medium 99 placed on the medium stage 5 are lifted (or inclined). More specifically, with the sheet supply roller 4 or the supporting portion 41 connected to the sheet supply roller 4 as a detection target, the stage up sensor SN5 is configured to detect that the detection target approaches or moves away, so that detect that the distal end portion and the leading edge of the print medium 99 placed on the medium stage 5 are lifted or lowered. In the description, the explanation is made assuming that the detection target is the protruding portion 43 disposed on the supporting portion 41. When the protruding portion 43 blocks light incident on the sensor portion, the stage up sensor SN5 becomes the on state.

In the embodiment, the image forming apparatus 1 is configured such that, once the medium cassette 3 is attached to the main body portion 2 while the power source is turned on, the medium stage 5 is maintained at a position before the power source is turned off with a stopper 71 (refer to FIG. 6(b), described later) even if the power source is turned off unless the medium cassette 3 is detached from the main body portion 2. Accordingly, once the medium cassette 3 is attached to the main body portion 2, the stage up sensor SN5 maintains the on state until the medium cassette 3 is detached from the main body portion 2. When the medium cassette 3 is detached from the main body portion 2, the stage up sensor SN5 becomes the off state. As a result, the stage up sensor SN5 is configured to function as a state detection portion for detecting the movement of the medium cassette 3 relative to the main body portion 2.

A configuration of a surrounding portion of the medium stage 5 will be explained in more detail next with reference to FIGS. 4 and 5. FIGS. 4 and 5 are schematic sectional views No. 3 and No. 4 showing the configuration of the medium storage portion and the surrounding portion thereof of the image forming apparatus according to the first embodiment of the present invention.

As shown in FIGS. 4 and 5, the medium cassette 3 includes a first gear 61, a second gear 62, and a gear teeth portion 63 on a right side surface thereof at a location near the distal end portion of the medium stage 5. The first gear 61 is arranged to engage with a drive gear 69 (refer to FIG. 6(a)) connected to the motor M1. Further, the first gear 61 has a center axis supported on the housing of the medium cassette 3 to be freely rotatable. The second gear 62 is configured as a planetary gear to circling around a circumference of the first gear 61. Further, the second gear 62 is arranged to engage with the first gear 61 and the gear teeth portion 63. The gear teeth portion 63 is formed in an arc shape and disposed at a location facing the first gear 61. Further, the gear teeth portion 63 is fixed to the housing of the medium cassette 3.

In the embodiment, the medium cassette 3 includes a third gear 64, a fourth gear 65, and a gear teeth portion 66 on a left side surface thereof at a location near the distal end portion of the medium stage 5. The third gear 64 is arranged on the left side surface of the medium cassette 3 at a location facing the first gear 61. Further, the third gear 64 has a center axis supported on the housing of the medium cassette 3 to be freely rotatable. The fourth gear 65 is configured as a planetary gear to circling around a circumference of the third gear 64. Further, the fourth gear 65 is arranged to engage with the third gear 64 and the gear teeth portion 66, and is connected to the second gear 62 through the medium stage movement shaft 51. The gear teeth portion 66 is formed in an arc shape and disposed at a location facing the third gear 64. Further, the gear teeth portion 66 is fixed to the housing of the medium cassette 3.

With the configuration described above, when the motor M1 (refer to FIG. 6(a)) drives the drive gear 69 to rotate, the first gear 61 engaging with the drive gear 69 is rotated in an arrow direction shown in FIGS. 4 and 5. When the first gear 61 is rotated, the second gear 62 engaging with the first gear 61 is rotated along the gear teeth portion 63 around the circumference of the first gear 61. Accordingly, the second gear 62 is moved upwardly (lifted) between the first gear 61 and the gear teeth portion 63.

In the embodiment, the second gear 62 is connected to the fourth gear 65 through the medium stage movement shaft 51. Accordingly, when the second gear 62 is moved, the fourth gear 65 is rotated and moved along the circumference of the third gear 64. As a result, the fourth gear 65 is synchronized with the movement of the second gear 62, and is moved upwardly (lifted) between the third gear 64 and the gear teeth portion 66.

In the embodiment, when the second gear 62 and the fourth gear 65 are moved upwardly, along with the movement, the medium stage movement shaft 51 is moved upwardly together with the second gear 62 and the fourth gear 65. Further, the medium stage movement shaft 51 is arranged to abut against the lower surface of the medium stage 5 near the distal end portion thereof. Accordingly, the distal end portion of the medium stage 5 is moved upwardly together with the medium stage movement shaft 51.

In the embodiment, the motor M1 is configured to drive only the first gear 61, and the third gear 64 is supported on the housing of the medium cassette 3 only at the center axis thereof to be freely rotatable. In the image forming apparatus 1, the medium stage 5, the first gear 61, the second gear 62, the gear teeth portion 63, and the gear teeth portion 66 constitute a lift mechanism for lifting the leading edge of the print medium 99.

With the configuration described above, the image forming apparatus 1 is configured such that the medium stage 5 is rotated around the shaft 52 as the rotational axis. Further, when the medium stage movement shaft 51 lifts the distal end portion of the medium stage 5, the medium stage 5 presses upwardly against the leading edge of the print medium 99 placed on the medium stage 5 from below. Accordingly, the leading edge of the print medium 99 abuts against the sheet supply roller 4.

In the embodiment, from the state described above, when the medium stage movement shaft 51 further lifts the distal end portion of the medium stage 5, the medium stage 5 presses upwardly against the sheet supply roller 4 through the print medium 99 from below, thereby lifting the sheet supply roller 4. At this moment, the image forming apparatus 1 is configured such that the medium stage movement shaft 51 lifts the distal end portion of the medium stage 5 until the protruding portion 43 blocks light incident on the stage up sensor SN5 so that the stage up sensor SN5 becomes the on state.

In the embodiment, in the image forming apparatus 1, a spring and the like (not shown) is provided for applying tension downwardly to the supporting portion 41 of the sheet supply roller 4. Further, in the image forming apparatus 1, when the protruding portion 43 makes the stage up sensor SN5 the on state, the distal end portion of the medium stage 5 stops being lifted. Accordingly, in this state, an optimal pressing force is applied to the print medium 99 so that the print medium 99 is smoothly picked up.

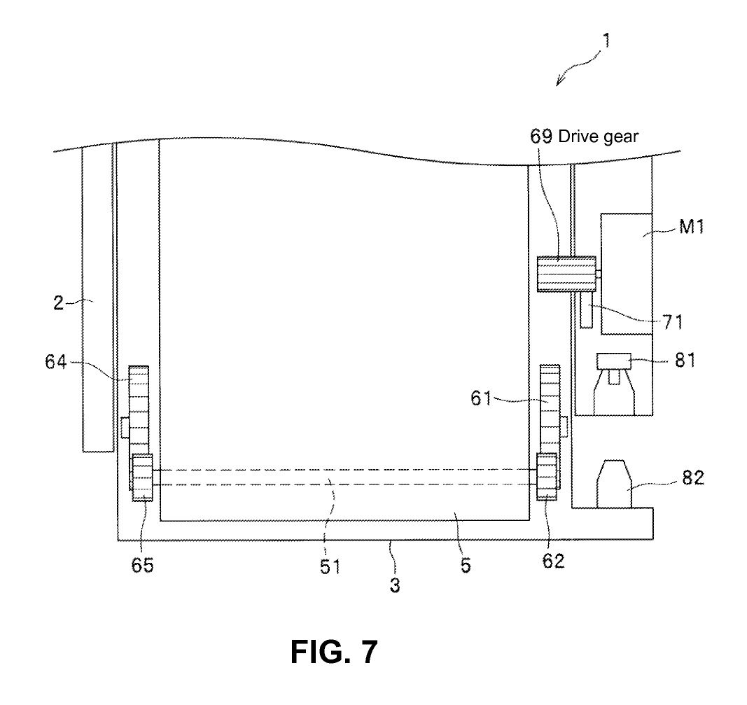

An operation of the medium cassette 3 and the surrounding portion thereof will be explained next with reference to FIGS. 6(a) and 6(b) and FIG. 7. FIGS. 6(a) and 6(b) are schematic views No. 1 showing the operation of the medium storage portion and the surrounding portion thereof of the image forming apparatus 1 according to the first embodiment of the present invention. FIG. 7 is a schematic view No. 2 showing the operation of the medium storage portion and the surrounding portion thereof of the image forming apparatus 1 according to the first embodiment of the present invention.

FIGS. 6(a) and 6(b) are the schematic views No. 1 showing the state that the medium cassette 3 is attached to the main body portion 2. FIG. 7 is the schematic view No. 2 showing the state that the medium cassette 3 is detached from the main body portion 2. Further, FIG. 6(a) is the schematic view No. 1 showing the entire configuration of the medium cassette 3 and the surrounding portion thereof viewed from above. FIG. 6(b) is the schematic view No. 1 showing the main configuration of the medium cassette 3 and the surrounding portion thereof viewed from the side.

As shown in FIGS. 6(a) and 7, the image forming apparatus 1 includes the motor M1. The motor M1 is a drive unit for driving the first gear 61 to rotate. More specifically, the motor M1 is configured to drive the first gear 61 to rotate through the drive gear 69 connected to the motor M1.

In the embodiment, the motor M1 and the drive gear 69 are attached to the main body portion 2 of the image forming apparatus 1. As shown in FIG. 6(a), in the state that the medium cassette 3 is attached to the main body portion 2, the first gear 61 is in the state of engaging with the drive gear 69. Accordingly, in the image forming apparatus 1, the motor M1 is capable of driving the first gear 61 to rotate.

In the embodiment, in the image forming apparatus 1, when the first gear 61 is driven and rotated, the medium stage movement shaft 51 is lifted. Accompanying with the movement of the medium stage movement shaft 51, the leading edge of the print medium 99 placed on the medium stage 5 is lifted. Accordingly, the motor M1 has a function of moving the print medium 99 as a medium moving portion.

In the embodiment, when the print medium 99 is lifted, the leading edge of the print medium 99 eventually abuts against the sheet supply roller 4, so that the sheet supply roller 4 is lifted. As a result, the protruding portion 43 disposed on the supporting portion 41 of the sheet supply roller 4 is lifted to enter the sensor portion (not shown) of the stage up sensor SN5, so that the protruding portion 43 blocks light incident on the stage up sensor SN5. Accordingly, the stage up sensor SN5 detects that the distal end portion of the medium stage 5 and the leading edge of the print medium 99 placed on the medium stage 5 are lifted.

Further, as shown in FIGS. 6(a) and 6(b), the image forming apparatus 1 includes the stopper 71. The stopper 71 is provided as a holding portion for holding the distal end portion of the medium stage 5 at the position before the power source is turned off even when the power source is turned off. The stopper 71 is formed of, for example, a plate spring member. Further, the stopper 71 includes a protruding portion 71a disposed at a distal end portion on a free end portion thereof. When the protruding portion 71a engages with the drive gear 69, the stopper 71 holds the position of the distal end portion of the medium stage 5, i.e., the detection target of the stage up sensor SN5 to be moved accompanying with the movement of the medium stage 5 (the protruding portion 43 disposed on the supporting portion 41 connected to the sheet supply roller 4).

In the embodiment, when the motor M1 drives the first gear 61 and the drive gear 69 to rotate in an arrow direction shown in FIG. 6(b), the transportation path 7 is moved away from the drive gear 69. Accordingly, the stopper 71 does not restrict the rotation of the drive gear 69.

However, when the first gear 61 and the drive gear 69 are rotated in a direction opposite to the arrow direction shown in FIG. 6(b), the stopper 71 is not moved away from the drive gear 69. Accordingly, in this case, the stopper 71 restricts the rotation of the drive gear 69.

For example, when the power source is turned off, and the motor M1 is in the non-conductive state, the first gear 61 and the drive gear 69 are rotated in the direction opposite to the arrow direction shown in FIG. 6(b) because of the weight of the medium stage 5 and the medium stage movement shaft 51 and the like. In this case, the protruding portion 71a of the stopper 71 engages with the drive gear 69. Accordingly, in this case, the stopper 71 restricts the rotation of the drive gear 69.

As described above, in the image forming apparatus 1, even when the power source is turned off, the stopper 71 holds the position of the distal end portion of the medium stage 5 at the lifted state as shown in FIG. 3.

In the embodiment, in the image forming apparatus 1, when the medium cassette 3 is detached from the main body portion 2, the first gear 61 is in the state of disengaging from the drive gear 69 as shown in FIG. 7. At this moment, no load is applied to the first gear 61. Accordingly, no load or a little load is applied to the medium stage 5 and the medium stage movement shaft 51, so that the medium stage 5 and the medium stage movement shaft 51 are lowered through their own weights. As a result, the medium stage 5 and the medium stage movement shaft 51 become the state shown in FIG. 2.

At this moment, in the image forming apparatus 1, the medium stage 5 functions as a release portion for releasing the print medium 99 away from the stage up sensor SN5, so that the pressing force generated with the motor M1 against the print medium 99 is removed. Accordingly, the leading edge of the print medium 99 is lowered. Further, the print medium 99 no longer presses against the sheet supply roller 4, so that the sheet supply roller 4 is lowered as well.

As a result, the sheet supply roller 4 is moved such that the protruding portion 43 disposed on the supporting portion 41 is moved away from the stage up sensor SN5. Accordingly, the protruding portion 43 stops blocking light incident on the stage up sensor SN5, so that the stage up sensor SN5 becomes the off state.

Through the operation described above, a medium stage control unit 115 (refer to FIG. 8) is capable of detecting the off state of the stage up sensor SN5 when the medium cassette 3 is detached from the main body portion 2 while the power source is being turned off.

Further, as shown in FIGS. 6(a) and 7, the image forming apparatus 1 includes a cassette switch 81. The cassette switch 81 is disposed on the side of the image forming apparatus 1. The cassette switch 81 functions as a attachment detection portion for detecting that the medium cassette 3 is attached to the main body portion 2.

As shown in FIG. 6(a), when the medium cassette 3 is attached to the main body portion 2, the cassette switch 81 is configured to engage with a protruding portion 82 disposed on the medium cassette 3, so that the cassette switch 81 becomes the on state. Accordingly, the image forming apparatus 1 is capable of detecting that the medium cassette 3 is attached to the main body portion 2.

On the other hand, as shown in FIG. 7, when the medium cassette 3 is detached from the main body portion 2, the cassette switch 81 is configured to disengage from the protruding portion 82, so that the cassette switch 81 becomes the off state. Accordingly, the image forming apparatus 1 is capable of detecting that the medium cassette 3 is detached from the main body portion 2 (the detachment of the medium cassette 3 from the main body portion 2).

A functional configuration of the image forming apparatus 1 will be explained next with reference to FIG. 8. FIG. 8 is a block diagram showing the functional configuration of the image forming apparatus 1 according to the first embodiment of the present invention. As shown in FIG. 8, the image forming apparatus 1 includes the control portion 110, the recording portion 120, and a communication unit 130.

In the embodiment, the control portion 110 is configured to execute a control program stored in a program storage unit 121 (described later) of the recording portion 120 in advance. Further, the control portion 110 includes an image forming control unit 111, a fixing control unit 114, a medium stage control unit 115, a transportation control unit 116, a medium thickness monitoring unit 117, and an operator panel control unit 119.

In the embodiment, the image forming control unit 111 is configured to control the image forming portion 11, the print head portion 12, and the transfer portion 13, so that the toner image as a print image is formed on the print medium 99 transported along the transportation path 7.

In the embodiment, the fixing control unit 114 is configured to control the fixing portion 14, so that the toner image formed on the print medium 99 is heated and melted, thereby fixing the toner image to the print medium 99.

In the embodiment, when the cassette switch 81 detects that the medium cassette 3 is attached to the main body portion 2, the medium stage control unit 115 drives the motor M1 to lift the medium stage 5. Accordingly, in the image forming apparatus 1, the print medium 99 abuts against the sheet supply roller 4, so that it is possible to supply the print medium 99. It is noted that the stage up sensor SN5 detects that the print medium 99 abuts against the sheet supply roller 4.

In the embodiment, the transportation control unit 116 is configured to start a monitor (not shown). Further, the transportation control unit 116 controls the sheet supply roller 4 and the transportation rollers 6A to 6E to transport the print medium 99, so that the transportation control unit 116 controls the transportation of the print medium 99 according to the information obtained through the transportation sensors SN2A to SN2C. Further, while the print medium 99 is being transported, the transportation control unit 116 controls the medium thickness sensor SN1 to detect the thickness of the print medium 99.

In the embodiment, the medium thickness monitoring unit 117 is configured as a medium characteristic monitoring unit for monitoring a medium characteristic (such as a thickness) of the print medium 99. Further, the medium thickness monitoring unit 117 is configured to store information (referred to as thickness information) indicating the thickness of the print medium 99 detected with the transportation control unit 116 as the information of the characteristic of the print medium 99 into a setting value storage unit 122 (described later) of the recording portion 120.

In the embodiment, the operator panel control unit 119 is configured as a function unit for controlling an operation of the operator panel 19. More specifically, the operator panel control unit 119 is configured to control the display portion 19a to display a specific screen and detect an input operation of a user through the operation portion 19b.

In the embodiment, the recording portion 120 is configured as a non-volatile memory. As described above, the recording portion 120 includes the program storage unit 121 and the setting value storage unit 122. The program storage unit 121 is a storage area for storing the control program in advance. The setting value storage unit 122 is a storage area for storing the thickness information of the print medium 99. Further, the setting value storage unit 122 is a medium characteristic storage unit for storing the information of the characteristic of the print medium 99 (the thickness information) used for controlling the operation of the image forming apparatus 1.

In the embodiment, the communication unit 130 is configured to receive print job data from a host computer 1000 as an upper device through a communication network, and to transmit the print job data to the control portion 110.

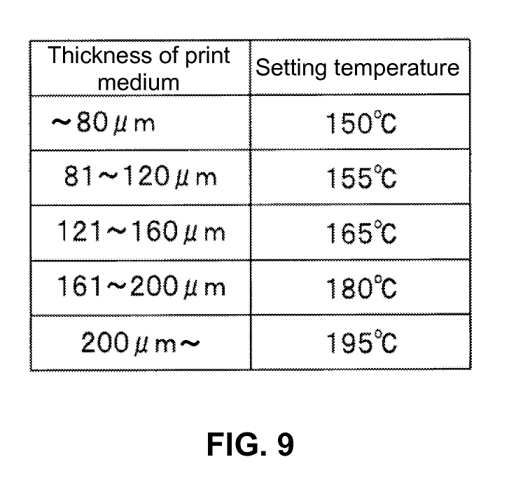

In the embodiment, the image forming apparatus 1 is configured to set a fixing target temperature of the fixing portion 14 according to the thickness of the print medium 99 as shown in FIG. 9 as an example. FIG. 9 is a table showing an example of a relationship between the thickness of the print medium 99 and the setting temperature of the fixing portion 14 of the image forming apparatus 1 according to the first embodiment of the present invention.

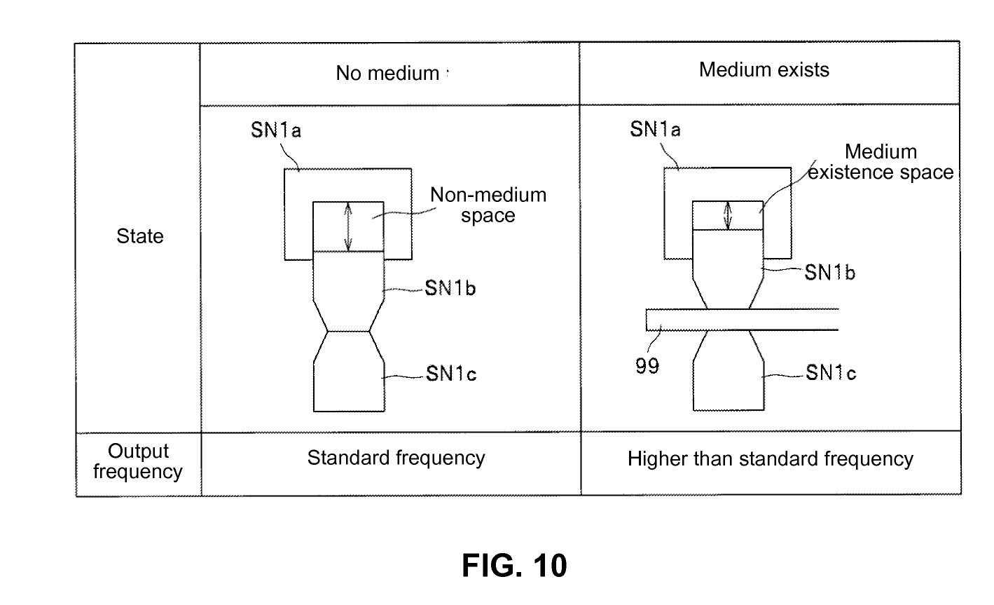

In the embodiment, it is configured such that the thickness of the print medium 99 is detected (measured) using an operational principle shown in FIG. 10. FIG. 10 is a schematic view showing the operation of the medium thickness sensor SN1 of the image forming apparatus 1 according to the first embodiment of the present invention. As shown in FIG. 10, the medium thickness sensor SN1 includes a sensor portion SN1a, a movable portion SN1b, and a base portion SN1c.

In the embodiment, the medium thickness sensor SN1 is a displacement sensor for outputting a detection signal having a specific frequency according to a distance between the movable portion SN1b and the medium thickness sensor SN1a. It is noted that the print medium 99 passes through between the medium thickness sensor SN1c and the medium thickness sensor SN1b.

As shown in FIG. 10, when the print medium 99 does not exist between the medium thickness sensor SN1c and the medium thickness sensor SN1b, a space between the medium thickness sensor SN1c and the medium thickness sensor SN1b is referred to as “a non-medium space”. Further, when the print medium 99 does exist between the medium thickness sensor SN1c and the medium thickness sensor SN1b, the space between the medium thickness sensor SN1c and the medium thickness sensor SN1b is referred to as “a medium existence space”.

As shown in the left side box in FIG. 10, when the print medium 99 does not exist between the medium thickness sensor SN1c and the medium thickness sensor SN1b, the medium thickness sensor SN1c contacts with the medium thickness sensor SN1b. In this case, the medium thickness sensor SN1a of the medium thickness sensor SN1 outputs a standard frequency corresponding to a static capacitance of the non-medium space to the control portion 110.

On the other hand, as shown in the right side box in FIG. 10, when the print medium 99 does exist between the medium thickness sensor SN1c and the medium thickness sensor SN1b, the medium thickness sensor SN1b moves toward the medium thickness sensor SN1a. Accordingly, in the medium thickness sensor SN1, the medium existence space becomes smaller than the non-medium space by the thickness of the print medium 99. In other words, the distance between the medium thickness sensor SN1b and the medium thickness sensor SN1a becomes smaller by the thickness of the print medium 99 when the print medium 99 exists between the medium thickness sensor SN1c and the medium thickness sensor SN1b.

Accordingly, the static capacitance of the space between the medium thickness sensor SN1b and the medium thickness sensor SN1a is changed. As a result, in the medium thickness sensor SN1, a frequency of the detection signal (referred to as an output frequency) output from the medium thickness sensor SN1a is changed.

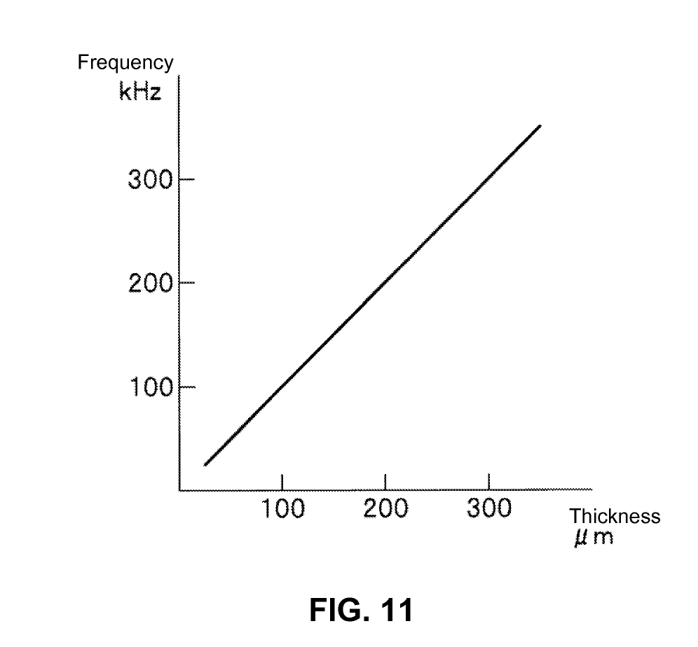

With the operation principle described above, the control portion 110 of the image forming apparatus 1 (more specifically, the transportation control unit 116) is capable of determining the thickness of the print medium 99 as shown in FIG. 11. FIG. 11 is a graph showing an example of a relationship between the thickness of the print medium 99 and the output frequency of the medium thickness sensor SN1 of the image forming apparatus 1 according to the first embodiment of the present invention.

With the configuration described above, when the power source is changed from the off state to the on state, and the stage up sensor SN5 does not detect that the medium cassette 3 is detached from the main body portion 2, the control portion 110 of the image forming apparatus 1 controls the setting value storage unit 122 to continue to store the information of the characteristic of the print medium 99 (the thickness information) before the power source becomes the off state. Further, when the power source is changed from the off state to the on state, and the stage up sensor SN5 does detect that the medium cassette 3 is detached from the main body portion 2, the control portion 110 of the image forming apparatus 1 controls the medium thickness sensor SN1 to identify the characteristic of the print medium 99, so that the information of the characteristic stored in the setting value storage unit 122 is updated.

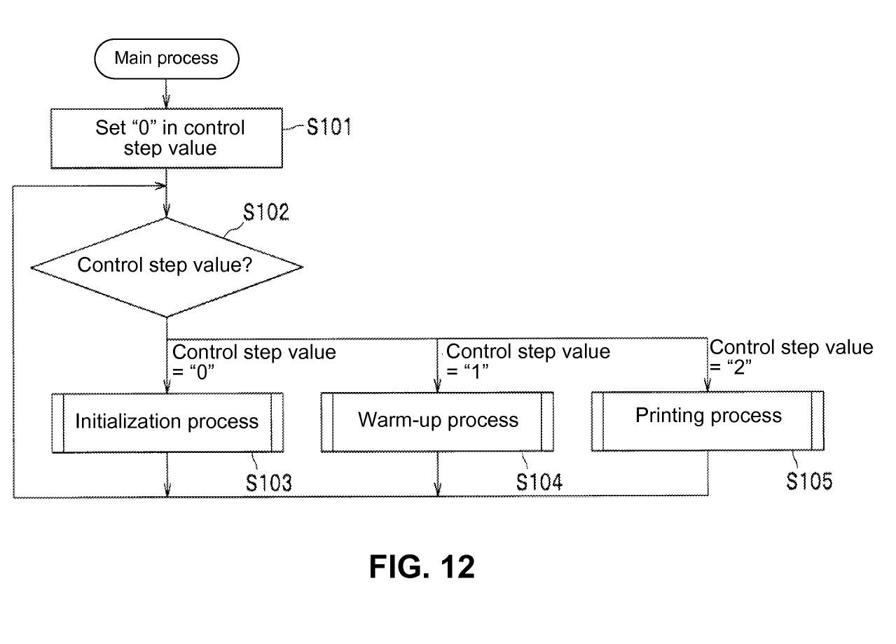

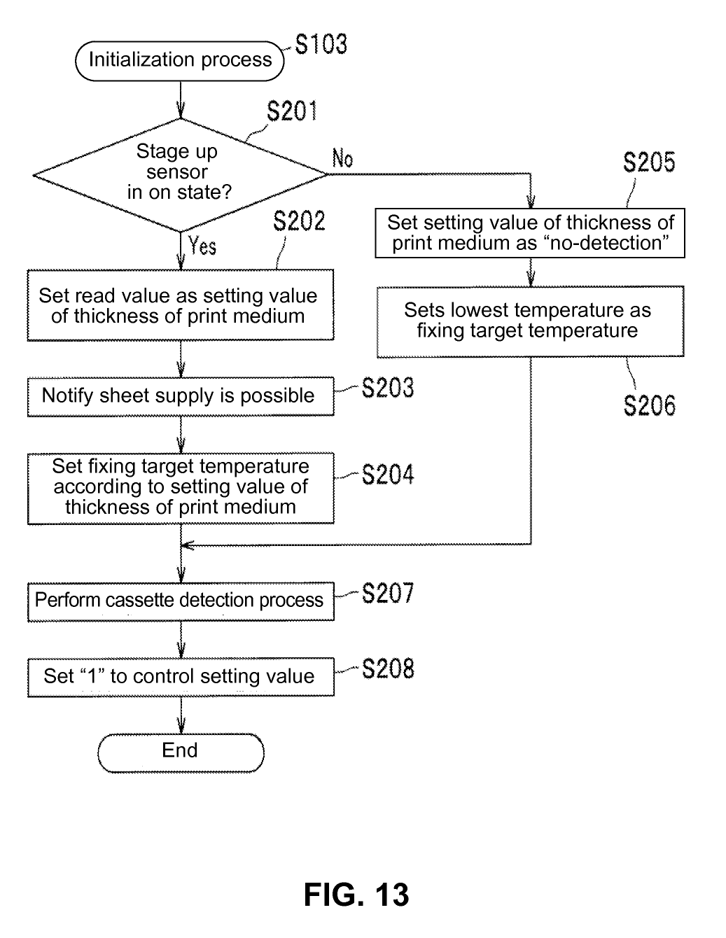

An operation of the image forming apparatus 1 will be explained next with reference to FIGS. 12 to 16. FIGS. 12 to 16 are flow charts No. 1 to No. 5 showing the operation of the image forming apparatus 1 according to the first embodiment of the present invention. More specifically, FIG. 12 is the flow chart No. 1 showing a main process. FIGS. 13 to 16 are the flow charts No. 2 to No. 5 showing sub-routine processes called from the main process.

First, the main process will be explained with reference to FIG. 12. When the user turns on the power source, the image forming apparatus 1 starts the operation. In step S101, after the power source is turned on, the control portion 110 of the image forming apparatus 1 sets “0” in a control step value. In step S102, the control portion 110 determines the control step value, so that the control portion 110 performs the branch process according to the control step value.

In step S103, when the control portion 110 determines that the control step value is “0”, the control portion 110 performs the initialization process shown in detail as the flow chart shown in FIG. 13.

As shown in FIG. 13, in the initialization process in step S103, in step S201, the medium stage control unit 115 of the control portion 110 (refer to FIG. 8) detects the state of the stage up sensor SN5, so that the medium stage control unit 115 determines whether the stage up sensor SN5 is in the on state when the power source is turned on. Then, the medium stage control unit 115 notifies the determination result to the medium thickness monitoring unit 117 (refer to FIG. 8).

As described above, in the embodiment, when the medium cassette 3 is attached to the main body portion 2, the distal end portion of the medium stage 5 is lifted (upward), so that the stage up sensor SN5 becomes the on state. At this moment, in the image forming apparatus 1, the protruding portion 71a of the stopper 71 (refer to FIG. 6(b)) engages with the drive gear 69. Accordingly, the position of the distal end portion of the medium stage 5 is maintained. As a result, once the stage up sensor SN5 becomes the on state, the stage up sensor SN5 is maintained in the on state.

Afterward, in the image forming apparatus 1, when the medium cassette 3 is detached from the main body portion 2, the first gear 61 is separated from the drive gear 69. Accordingly, the medium stage 5 and the medium stage movement shaft 51 are lowered by own weights. As a result, the leading edge of the print medium 99 is lowered, and the sheet supply roller 4 is also lowered. As a result, the protruding portion 43 disposed on the supporting portion 41 of the sheet supply roller 4 is separated from the stage up sensor SN5, so that the stage up sensor SN5 becomes the off state.

Accordingly, when the power source is turned off, and the medium cassette 3 is detached from the main body portion 2, the stage up sensor SN5 becomes the off state. Therefore, the medium stage control unit 115 is capable of detecting the off state of the stage up sensor SN5.

When the medium stage control unit 115 determines that the stage up sensor SN5 is in the on state in step S201 (Yes) while the power source is turned on, the medium thickness monitoring unit 117 determines that the medium cassette 3 is not detached from the main body portion 2 to replenish or exchange the print medium 99 while the power source is turned on.

In this case, as described above, the medium thickness monitoring unit 117 controls the setting value storage unit 122 of the recording portion 120 to continue to store the thickness information of the print medium 99 before the power source is turned off. Then, the medium thickness monitoring unit 117 retrieves from the setting value storage unit 122 the thickness information of the print medium 99 before the power source is turned off.

In step S202, the medium thickness monitoring unit 117 sets the value (the read value) of the thickness information of the print medium 99 before the power source is turned off as the setting value of the characteristic feature (the thickness) of the print medium 99 used for controlling the operation of the image forming apparatus 1. In step S203, the medium thickness monitoring unit 117 notifies the transportation control unit 116 that the sheet supply is possible (possible to supply the print medium 99).

In step S204, the fixing control unit 114 (refer to FIG. 8) sets the fixing target temperature of the fixing portion 14 shown as the example in FIG. 9 according to the setting value of the thickness of the print medium 99.

On the other hand, when the medium stage control unit 115 determines that the stage up sensor SN5 is not in the on state (the off state) in step S201 (No) while the power source is turned on, the medium thickness monitoring unit 117 determines that the medium cassette 3 is detached from the main body portion 2 to replenish or exchange the print medium 99 while the power source is turned off.

In step S205, the medium thickness monitoring unit 117 sets the setting value of the thickness of the print medium 99 as “no-detection”, so that the thickness of the print medium 99 is detected. In step S206, the fixing control unit 114 sets the lowest temperature among the fixing target temperatures of the fixing portion 14 shown in FIG. 9 as an example as the fixing target temperature of the fixing portion 14. In general, when the fixing portion 14 is heated under control, it tends to take a longer period of time to cool the fixing portion 14. When the fixing control unit 114 sets the lowest temperature among the fixing target temperatures of the fixing portion 14, it is possible to prevent a prolonged waiting time for cooling the fixing portion 14.

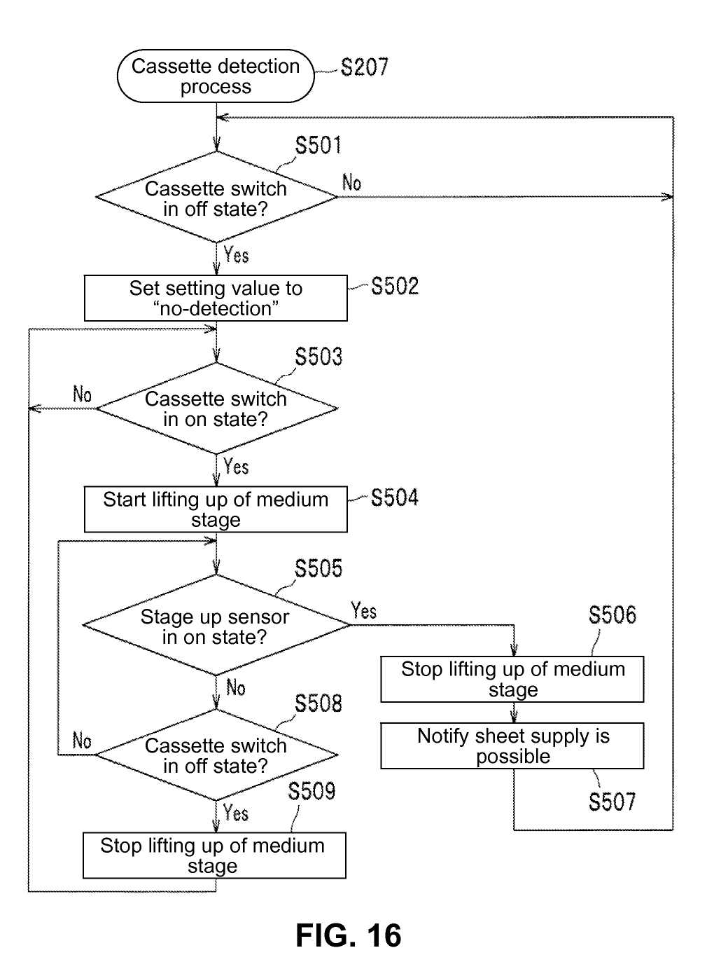

After step S204 or step S206, in step S207, the control portion 110 performs a cassette detection process shown in FIG. 16 to detect whether the medium cassette 3 is detached from the main body portion 2. In step S208, the control portion 110 sets “1” to the control setting value, thereby completing the initialization process in step S103. Afterward, the process returns to step S102 shown in FIG. 12. As a result, afterward, the cassette detection process shown in FIG. 16 is performed along with a warm-up process or a printing process shown in FIG. 12 until the power source is turned off.

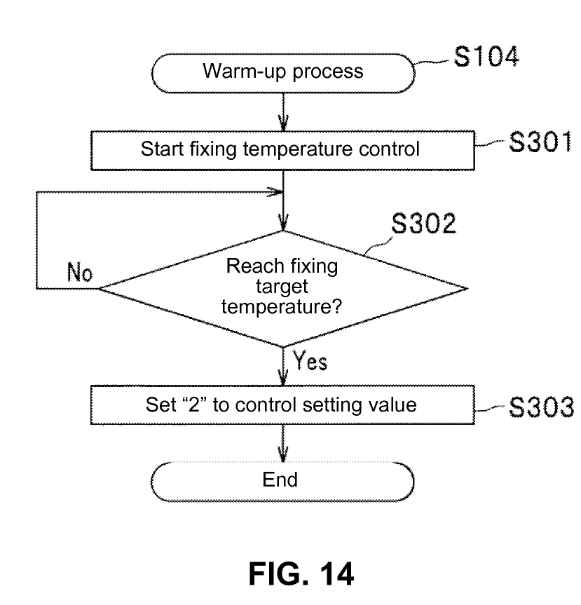

When the process returns to step S102, the control portion 110 determines that “1” is set to the control step value in step S102. Accordingly, in step S104, the control portion 110 performs the warm-up process. The warm-up process is shown in detail as the flow chart shown in FIG. 14.

As shown in FIG. 14, in the warm-up process in step S104, in step S301, the fixing control unit 114 of the control portion 110 starts a fixing temperature control for increasing the temperature of the fixing portion 14 to the fixing target temperature. In step S302, the fixing control unit 114 repeatedly determines whether the temperature of the fixing portion 14 reaches the fixing target temperature until the temperature of the fixing portion 14 reaches the fixing target temperature.

When the fixing control unit 114 determines that the temperature of the fixing portion 14 does not reach the fixing target temperature in step S302 (No), the control portion 110 waits until the temperature of the fixing portion 14 reaches the fixing target temperature.

When the fixing control unit 114 determines that the temperature of the fixing portion 14 reaches the fixing target temperature in step S302 (Yes), the fixing temperature control of the fixing portion 14 is completed. In this case, in step S303, the control portion 110 sets “2” to the control setting value. Accordingly, the control portion 110 completes the warm-up process in step S104. Afterward, the fixing control unit 114 maintains the temperature of the fixing portion 14 at the fixing target temperature. Then, the process returns to step S102.

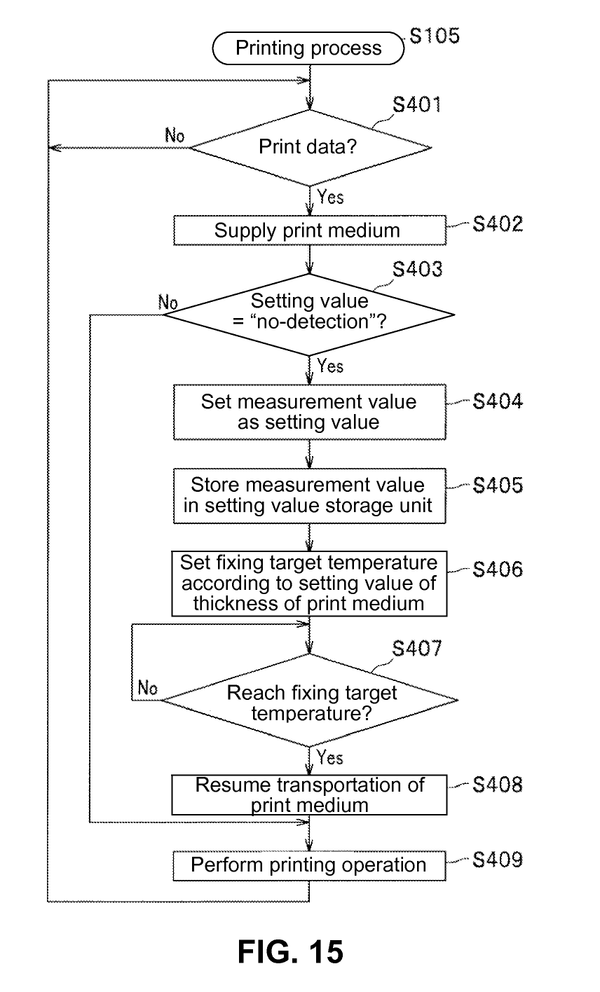

When the process returns to step S102, the control portion 110 determines that “2” is set to the control step value in step S102. Accordingly, in step S105, the control portion 110 performs the printing process. The printing process is shown in detail as the flow chart shown in FIG. 15.

As shown in FIG. 15, in the printing process in step S105, in step S401, the image forming control unit 111 of the control portion 110 (refer to FIG. 8) repeatedly determines whether there are the print data received from the host computer 1000 as the upper device until the image forming control unit 111 determines that there are the print data.

When the image forming control unit 111 determines that there are not the print data in step S401 (No), the control portion 110 waits until the communication unit 130 (refer to FIG. 8) receives the print data.

On the other hand, when the image forming control unit 111 determines that there are the print data in step S401 (Yes), the transportation control unit 116 of the control portion 110 (refer to FIG. 8) drives the sheet supply roller 4 and the transportation rollers 6A and 6B to supply the print medium 99 from the medium cassette 3 in step S402, so that the transportation of the print medium 99 is started.

In step S403, the transportation control unit 116 determines whether the setting value of the thickness of the print medium 99 is “no-detection”.

When the transportation control unit 116 determines that the setting value of the thickness of the print medium 99 is “no-detection” in step S403 (Yes), the transportation control unit 116 temporarily stops the transportation of the print medium 99 at the timing when the print medium 99 reaches the medium thickness sensor SN1, so that the medium thickness sensor SN1 detects (measures) the thickness of the print medium 99. In step S404, the medium thickness monitoring unit 117 (refer to FIG. 8) sets the thickness of the print medium 99 (referred to as the measurement value) thus detected (measured) as the setting value of the thickness of the print medium 99. In step S405, the measurement value is stored in the setting value storage unit 122 of the recording portion 120 (refer to FIG. 8). At this time, it is noted that the setting value storage unit 122 is formed of a non-volatile memory such as, for example, an EEPROM and an FROM (Flash Read Only Memory), so that the measurement value is not erased even after the power source is turned off.

In the embodiment, when the thickness of the print medium 99 is detected, the transportation control unit 116 temporarily stops the transportation of the print medium 99. This is because if the print medium 99 is transported at the time of the detection, the output of the medium thickness sensor SN1 tends to be unstable, thereby making it difficult to accurately measure the thickness of the print medium 99.

After step S405, in step S406, the fixing control unit 114 of the control portion 110 (refer to FIG. 8) sets the fixing target temperature of the fixing portion 14 according to the setting value of the thickness of the print medium 99, so that the fixing control unit 114 starts the temperature adjustment of the fixing portion 14. In step S407, the fixing control unit 114 repeatedly determines whether the temperature of the fixing portion 14 reaches the fixing target temperature until the temperature of the fixing portion 14 reaches the fixing target temperature.

When the fixing control unit 114 determines that the temperature of the fixing portion 14 does not reach the fixing target temperature in step S407 (No), the control portion 110 waits until the temperature of the fixing portion 14 reaches the fixing target temperature.

On the other hand, when the fixing control unit 114 determines that the temperature of the fixing portion 14 reaches the fixing target temperature in step S407 (Yes), in step S408, the transportation control unit 116 of the control portion 110 (refer to FIG. 8) drives the transportation rollers 6C to 6E, so that the transportation of the print medium 99 is resumed.

In step S409, the image forming control unit 111 and the fixing control unit 114 of the control portion 110 (refer to FIG. 8) drive the image forming portion 11, the print head portion 12, the transfer portion 13, and the fixing portion 14, so that the printing operation is performed. As a result, after the toner image is formed on the photosensitive drum 11a according to the print job data, the toner image is transferred to the print medium 99. After the toner image is transferred to the print medium 99, the fixing portion 14 heats and presses the toner image to melt, so that the toner image is fixed to the print medium 99. Afterward, the process returns to step S401. Accordingly, the process from step S401 to step S409 is repeated until the power source is turned off, or the medium cassette 3 is detached from the main body portion 2, or another process (not shown) is instructed through an interruption instruction.

When the transportation control unit 116 determines that the setting value of the thickness of the print medium 99 is not “no-detection” in step S403 (No), the thickness of the print medium 99 is not detected. In step S409, the image forming control unit 111 and the fixing control unit 114 of the control portion 110 (refer to FIG. 8) drive the image forming portion 11, the print head portion 12, the transfer portion 13, and the fixing portion 14, so that the printing operation is performed.

In the embodiment, the image forming apparatus 1 performs the printing process shown in FIG. 15 until the power source is turned off, or the medium cassette 3 is detached from the main body portion 2, or another process (not shown) is instructed through an interruption instruction. It should be noted that when the power source is turned off, the image forming apparatus 1 performs the main process shown in FIG. 12 from step S101 again once the power source is turned on.

As described above, in the image forming apparatus 1, when the power source is turned on, the medium stage control unit 115 (refer to FIG. 8) determines whether the stage up sensor SN5 is in the on state (refer to step S201 shown in FIG. 13). Then, the medium stage control unit 115 notifies the determination result to the medium thickness monitoring unit 117. Accordingly, the medium thickness monitoring unit 117 determines whether the medium cassette 3 is detached from the main body portion 2 while the power source is being turned off according to the determination result (that is, whether the stage up sensor SN5 is in the on state or the off state).

In the embodiment, when the medium thickness monitoring unit 117 determines that the medium cassette 3 is not detached from the main body portion 2 while the power source is being turned off (that is, the print medium 99 is not replenished or exchanged while the power source is being turned off), the medium thickness monitoring unit 117 sets the value of the thickness information of the print medium 99 (the read value) read from the setting value storage unit 122 of the recording portion 120 as the setting value of the thickness of the print medium 99. As a result, the fixing control unit 114 (refer to FIG. 8) sets the fixing target temperature of the fixing portion 14 according to the read value set as the setting value of the thickness of the print medium 99.

Accordingly, in the image forming apparatus 1, when the print medium 99 is not replenished or exchanged while the power source is being turned off, it is not necessary to the detection process of the thickness of the print medium 99 or the temperature adjustment process of the fixing portion 14 according to the detection result thereof. As a result, in the image forming apparatus 1, it is possible to shorten a period of time from when the power source is turned on to when the printing operation is performed on the first sheet.

Next, the cassette detection process (refer to step S207 shown in FIG. 13) will be explained with reference to FIG. 16. FIG. 16 is the flow chart No. 5 showing the cassette detection process of the image forming apparatus 1 for detecting that the medium cassette 3 is detached from the main body portion 2 according to the first embodiment of the present invention.

As described above, the cassette detection process is performed along with the warm-up process or the printing process in the main process shown in FIG. 12. After the initialization process is completed. the image forming apparatus 1 is configured to monitor whether the medium cassette 3 is detached from the main body portion 2 all the time.

As shown in FIG. 16, in step S207 shown in FIG. 13, the image forming apparatus 1 starts the cassette detection process. Accordingly, the medium stage control unit 115 (refer to FIG. 8) monitors the state of the cassette switch 81. More specifically, in step S501, the medium stage control unit 115 repeatedly determines whether the cassette switch 81 is in the off state due to the separation of the protruding portion 82 until the cassette switch 81 becomes the off state. It is noted that when the cassette switch 81 becomes the off state, the medium cassette 3 is detached from the main body portion 2 as shown in FIG. 7.

When the medium stage control unit 115 determines that the cassette switch 81 is not in the off state in step S501 (No), the medium stage control unit 115 waits until the cassette switch 81 becomes the off state.

On the other hand, when the medium stage control unit 115 determines that the cassette switch 81 is in the off state in step S501 (Yes), that is, the medium cassette 3 is detached from the main body portion 2, the medium stage control unit 115 notifies that the cassette switch 81 becomes the off state to the medium thickness monitoring unit 117. In step S502, the medium thickness monitoring unit 117 sets the setting value of the thickness of the print medium 99 to the value representing “no-detection”. Accordingly, when the printing process is performed in the next time, the image forming apparatus 1 detects the thickness of the print medium 99 again (refer to step S404 shown in FIG. 15).

In step S503, the medium stage control unit 115 (refer to FIG. 8) repeatedly determines whether the cassette switch 81 is in the on state until the cassette switch 81 becomes the on state. It is noted that when the cassette switch 81 becomes the on state, the medium cassette 3 is attached to the main body portion 2.

When the medium stage control unit 115 determines that the cassette switch 81 is not in the on state in step S503 (No), the medium stage control unit 115 waits until the cassette switch 81 becomes the on state.

On the other hand, when the medium stage control unit 115 determines that the cassette switch 81 is in the on state in step S503 (Yes), that is, the medium cassette 3 is attached to the main body portion 2, the medium stage control unit 115 drives the motor M1, so that the lifting up of the medium stage 5 is started in step S504. Then, the medium stage control unit 115 monitors the state of the stage up sensor SN5.

In step S505, the medium stage control unit 115 repeatedly determines whether the stage up sensor SN5 is in the on state until the stage up sensor SN5 becomes the on state due to the light blocking of the protruding portion 43. It is noted that when the stage up sensor SN5 becomes the on state, the print medium 99 abuts against the sheet supply roller 4 as shown in FIG. 3.

When the medium stage control unit 115 determines that the stage up sensor SN5 is in the on state in step S505 (Yes), that is, the print medium 99 abuts against the sheet supply roller 4, the medium stage control unit 115 stops driving the motor M1, so that the lifting up of the medium stage 5 is stopped in step S506. In step S507, the medium stage control unit 115 notifies that the sheet supply is possible (the sheet can be supplied) to the transportation control unit 116. After step S507, the process returns to step S501.

When the medium stage control unit 115 determines that the stage up sensor SN5 is not in the on state in step S505 (No), that is, the print medium 99 does not abut against the sheet supply roller 4, the medium stage control unit 115 determines whether the cassette switch 81 is in the off state in step S508 until the cassette switch 81 becomes the off state.

When the medium stage control unit 115 determines that the cassette switch 81 becomes the off state in step S508 (Yes), that is, the medium cassette 3 is detached from the main body portion 2, the medium stage control unit 115 determines that the medium cassette 3 is detached from the main body portion 2 while the medium stage 5 is being lifted up. In step S509, the medium stage control unit 115 stops driving the motor M1, so that the lifting up of the medium stage 5 is stopped. After step S509, the process returns to step S503. Then, the image forming apparatus 1 is in the waiting state until the user attaches the medium cassette 3 to the main body portion 2.

On the other hand, when the medium stage control unit 115 determines that the cassette switch 81 is not in the off state in step S508 (No), that is, the medium cassette 3 is not detached from the main body portion 2, the process returns to step S505. Accordingly, the medium stage control unit 115 repeats the determination process in step S505 and step S508.

In the embodiment, in the image forming apparatus 1, the setting value of the characteristic feature (the thickness) of the print medium 99 to be used for controlling the operation thereof is changed as follows.

As shown in FIG. 13, in step S201, the medium stage control unit 115 of the image forming apparatus 1 (refer to FIG. 8) determines whether the stage up sensor SN5 (refer to FIGS. 2 and 3) is in the on state when the power source is turned on.

When the medium stage control unit 115 determines that the stage up sensor SN5 is in the on state in step S201 (Yes), in step S202, the medium thickness monitoring unit 117 (refer to FIG. 8) reads the value (the read value) of the thickness information of the print medium 99 before the power source is turned off from the setting value storage unit 122, and sets the read value as the setting value of the thickness of the print medium 99. Afterward, the image forming apparatus 1 performs the cassette detection process in step S207 along with the main process shown in FIG. 12.

In the embodiment, the setting value of the thickness of the print medium 99 is maintained in the state as set until it is detected that the medium cassette 3 is detached from the main body portion 2 (that is, the cassette switch 81 becomes the off state in step S501 shown in FIG. 16).

On the other hand, when the medium stage control unit 115 determines that the stage up sensor SN5 is not in the on state in step S201 (No), in step S205, the medium thickness monitoring unit 117 sets the setting value of the thickness of the print medium 99 as “no-detection”. Afterward, the image forming apparatus 1 performs the cassette detection process in step S207 along with the main process shown in FIG. 12.

Further, when the image forming apparatus 1 performs the printing process (refer to step S105 shown in FIG. 12), the image forming apparatus 1 detects (measures) the thickness of the print medium 99 in step S404 shown in FIG. 15. At this moment, the medium thickness monitoring unit 117 sets the thickness (the measurement value) of the print medium 99 thus detected (measured) as the setting value of the thickness of the print medium 99.

Afterward, the setting value of the thickness of the print medium 99 is maintained in the measurement value as set until it is detected that the medium cassette 3 is detached from the main body portion 2 (that is, the cassette switch 81 becomes the off state in step S501 shown in FIG. 16).

It is noted that when it is detected that the medium cassette 3 is detached from the main body portion 2 (that is, the cassette switch 81 becomes the off state in step S501 shown in FIG. 16), the medium thickness monitoring unit 117 sets the setting value of the thickness of the print medium 99 as “no-detection” in step S502 shown in FIG. 16.

With the configuration described above, in the image forming apparatus 1, when the medium cassette 3 is not detached from the main body portion 2 while the power source is being turned off, that is, the print medium 99 is not replenished or exchanged while the power source is being turned off, the control portion 110 controls the operation of each component (especially, the fixing portion 14) according to the information (the thickness information) of the characteristic feature of the print medium 99 before the power source is turned off read from the medium characteristic storage unit (the setting value storage unit 122).

Accordingly, in the image forming apparatus 1, it is not necessary to perform the detection process of the characteristic feature of the print medium 99 and the temperature adjustment process of the fixing portion 14 according to the detection result when the print medium 99 is not replenished or exchanged while the power source is being turned off. As a result, it is possible to shorten a period of time from when the power source is turned on to when the printing operation is performed on the first sheet.

As described above, in the image forming apparatus 1 in the first embodiment, when the print medium 99 is not replenished or exchanged while the power source is being turned off, it is not necessary to perform the detection process of the characteristic feature (the thickness) of the print medium 99 and the temperature adjustment process of the fixing portion 14 according to the detection result. As a result, it is possible to shorten a period of time from when the power source is turned on to when the printing operation is performed on the first sheet.

### Second Embodiment

A second embodiment of the present invention will be explained next. In the second embodiment, the image forming apparatus 1 is provided with an additional function of alerting the user that the print medium 99 is exchanged when the print medium 99 stored in the medium cassette 3 is exchanged.

In the second embodiment, the image forming apparatus 1 has a configuration similar to that in the first embodiment, and performs an additional operation.

In the following description, a difference in the operation of the image forming apparatus 1 in the second embodiment from that in the first embodiment will be mainly explained. Other operations of the image forming apparatus 1 in the second embodiment are similar to those in the first embodiment (refer to FIGS. 12 to 16), and explanations thereof are omitted.

In the second embodiment, when the image forming apparatus 1 alerts the user that the print medium 99 is exchanged, the image forming apparatus 1 is configured to display a screen (referred to as a medium exchange alert screen) on the display portion 19a (refer to FIG. 8), so that the user is alerted that the print medium 99 is exchanged. Further, when a medium exchange alert is performed, the medium exchange alert screen is displayed on the display portion 19a.

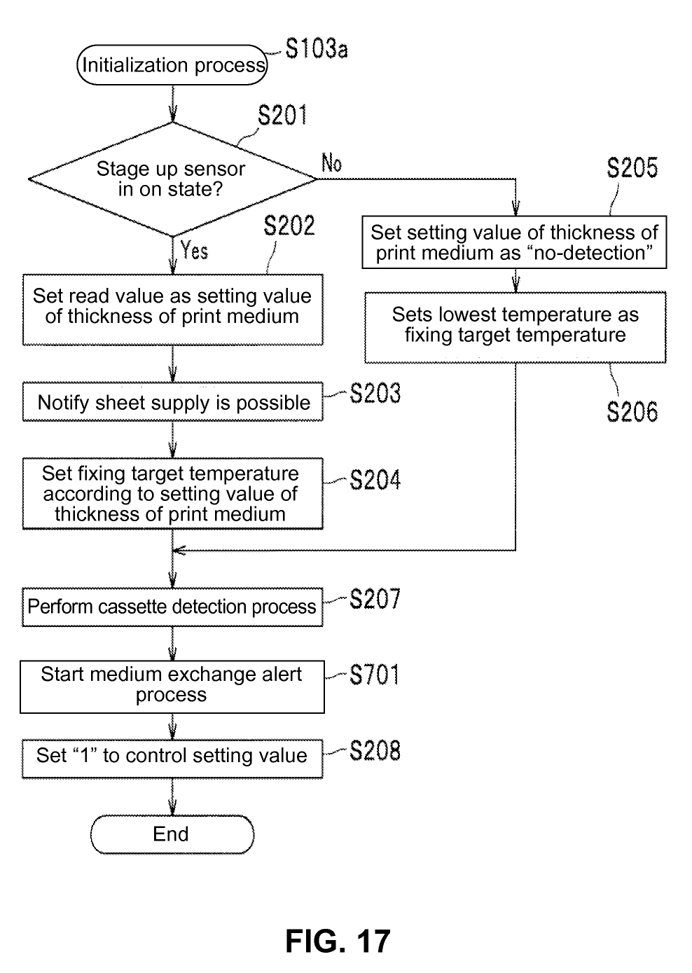

FIGS. 17 to 19 are flow charts No 1 to No. 3 showing the operation of the image forming apparatus 1 according to the second embodiment of the present invention.

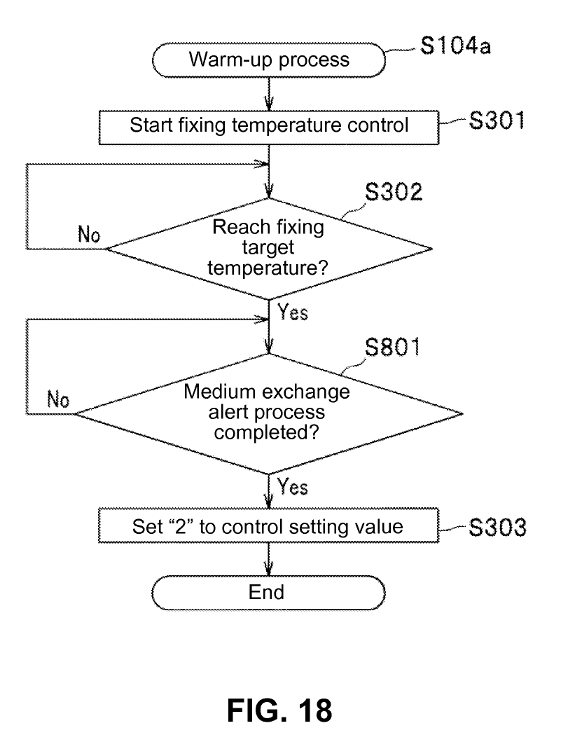

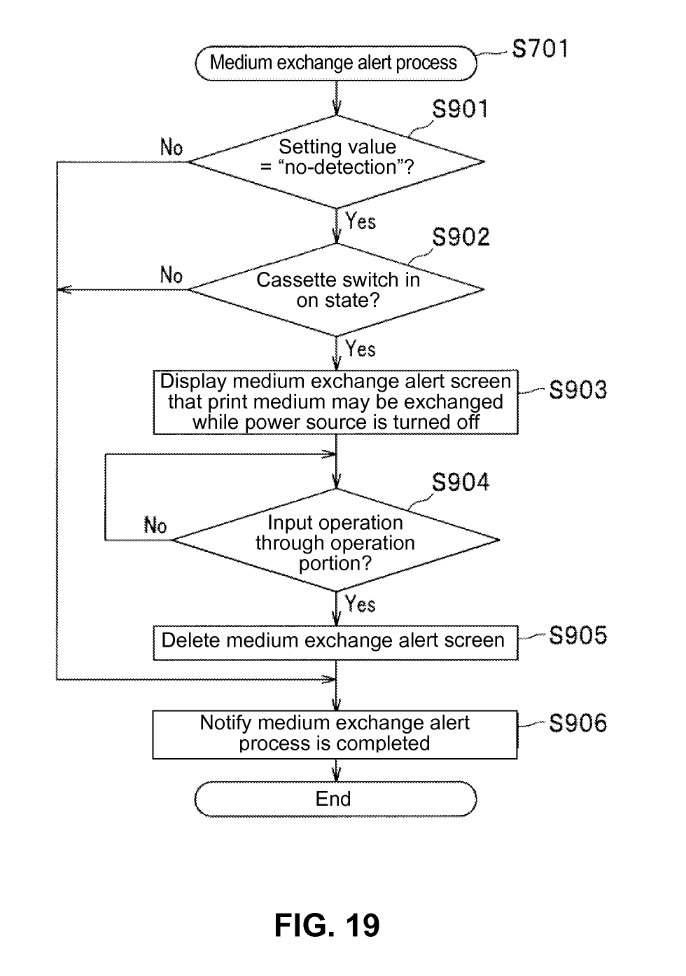

In the second embodiment, when the image forming apparatus 1 performs the initialization process, instead of performing the initialization process in step S103 shown in FIG. 13 in the first embodiment, the image forming apparatus 1 performs the initialization process in step S103a shown in FIG. 17. Further, when the image forming apparatus 1 performs the warm-up process, instead of performing the warm-up process in step S104 shown in FIG. 14 in the first embodiment, the image forming apparatus 1 performs the warm-up process in step S104a shown in FIG. 18. Further, the image forming apparatus 1 performs the medium exchange alert process in step S701 shown in FIG. 19.

FIG. 17 is the flow chart No. 1 showing the initialization process of the image forming apparatus 1 according to the second embodiment of the present invention. As compared with the initialization process in step S103 shown in FIG. 13, the initialization process in step S103a shown in FIG. 17 includes step S701 between step S207 and step S208.

In step S207, the image forming apparatus 1 starts the cassette detection process shown in FIG. 16. In step S701, the control portion 110 of the image forming apparatus 1 starts the medium exchange alert process. The medium exchange alert process will be explained in more detail later with reference to FIG. 19. In step S208, the control portion 110 sets “1” to the control set value, thereby completing the initialization process in step S103a.

FIG. 18 is the flow chart No. 2 showing the warm-up process of the image forming apparatus 1 according to the second embodiment of the present invention. As compared with the warm-up process in step S104 shown in FIG. 14, the warm-up process in step S104a shown in FIG. 18 includes step S801 between step S302 and step S303.

In step S302, the control portion 110 of the image forming apparatus 1 repeatedly determines whether the temperature of the fixing portion 14 reaches the fixing target temperature. When the control portion 110 determines that the temperature of the fixing portion 14 reaches the fixing target temperature in step S302 (Yes), in step S801, the control portion 110 repeatedly determines whether the medium exchange alert process is completed until the medium exchange alert process is completed.

When the control portion 110 determines that the medium exchange alert process is not completed in step S801 (No), the control portion 110 waits until the medium exchange alert process is completed. On the other hand, when the control portion 110 determines that the medium exchange alert process is completed in step S801 (Yes), the control portion 110 sets “2” to the control set value, thereby completing the warm-up process in step S104a.

As described above, the image forming apparatus 1 starts performing the medium exchange alert process in step S701 shown in FIG. 17 during the initialization process. Further, the image forming apparatus 1 performs the medium exchange alert process along with the warm-up process in step S104a.

In step S901, the transportation control unit 116 of the image forming apparatus 1 (refer to FIG. 8) determines whether the setting value of the thickness of the print medium 99 is the value indicating “no-detection”. In particular, the transportation control unit 116 refers the setting value of the print medium 99 set in step S202 or step S205 shown in FIG. 17.

When the transportation control unit 116 determines that the setting value of the thickness of the print medium 99 is the value indicating “no-detection” in step S901 (Yes), in step S902, the medium stage control unit 115 of the image forming apparatus 1 (refer to FIG. 8) determines whether the cassette switch 81 is in the on state.

When the cassette switch 81 becomes the on state, that is, the medium cassette 3 becomes the attached state to the main body portion 2, it is indicated that the print medium 99 stored in the medium cassette 3 may be exchanged while the power source is being turned off.

When the medium stage control unit 115 determines that the cassette switch 81 is in the on state, that is, the medium cassette 3 becomes the attached state to the main body portion 2, in step S902 (Yes), in step S903, the operator panel control unit 119 of the image forming apparatus 1 (refer to FIG. 8) displays the medium exchange alert screen on the display portion 19a, so that the user is alerted that the print medium 99 stored in the medium cassette 3 may be exchanged while the power source is being turned off.

After step S903, in step S904, the operator panel control unit 119 repeatedly determines whether the user inputs through the operation portion 19b until the user performs the input operation through the operation portion 19b, so that the user surely notices that the medium exchange alert screen is displayed. Accordingly, in the image forming apparatus 1, the medium exchange alert screen is continuously displayed until the user surely notices that the medium exchange alert screen is displayed. When the operator panel control unit 119 determines that the user inputs through the operation portion 19b in step S904 (Yes), in step S905, the operator panel control unit 119 controls the display portion 19a to delete the medium exchange alert screen. In step S906, the operator panel control unit 119 notifies that the medium exchange alert process is completed to the medium thickness monitoring unit 117 (refer to FIG. 8), thereby completing the medium exchange alert process.

When the operator panel control unit 119 determines that the user does not input through the operation portion 19b in step S904 (No), or the medium stage control unit 115 determines that the cassette switch 81 is not in the on state, that is, the medium cassette 3 does not become the attached state to the main body portion 2, in step S902 (No), the process proceeds to step S906.

As described above, the image forming apparatus 1 notifies the user that the print medium 99 stored in the medium cassette 3 may be exchanged while the power source is being turned off. In this case, the user can confirm the print medium 99 stored in the medium cassette 3. When a size of the print medium 99 is different from the proper size, the user can exchange the print medium 99 in the medium cassette 3. Alternatively, the user may reset the size of the print medium 99 through a printer driver and the like.

When the image forming apparatus 1 confirms that the temperature adjustment process of the fixing portion 14 and the medium exchange alert process are completed in the warm-up process in step S104a shown in FIG. 18, the control portion 110 set “2” to the control step value. Accordingly, the warm-up process in step S104a is completed.

As described above, in the image forming apparatus 1 in the second embodiment, in addition to the effects of the image forming apparatus 1 in the first embodiment, it is possible to notify to the user that the print medium 99 stored in the medium cassette 3 may be exchanged while the power source is being turned off. In this case, the user can confirm the print medium 99 stored in the medium cassette 3. When a size of the print medium 99 is different from the proper size, the user can exchange the print medium 99 in the medium cassette 3. Alternatively, the user may reset the size of the print medium 99 through a printer driver and the like. Accordingly, the user can prevent the print medium 99 that is not intended to use from being printed.

It is noted that the present invention is not limited to the above embodiments, and may be modified within a scope thereof.

In the first and second embodiments, the image forming apparatus 1 is the printer. The present invention is not limited to the printer, and may be applicable to an image forming apparatus such as, for example, a facsimile, a copier, a MFP (Multi Function Printer), and the like. The

MFP has a facsimile function, a scanner function, a copier function, and the like, in addition to the printer function.

Further, in the first and second embodiments, the medium thickness sensor SN1 for detecting the thickness of the print medium 99 is provided as the medium characteristic identifying portion for identifying the characteristic feature of the print medium 99. Alternatively, a medium type detection sensor for detecting the type of print medium such as an OHP sheet may be provided as the medium characteristic identifying portion.

The disclosure of Japanese Patent Application No. 2011-236363, filed on Oct. 27, 2011, is incorporated in the application.

While the invention has been explained with reference to the specific embodiments of the invention, the explanation is illustrative and the invention is limited only by the appended claims.

What is claimed is:

1. An image forming apparatus comprising:
an image forming portion for forming an image on a medium;
a main body portion for retaining the image forming portion;
a medium storage portion arranged to be detachable relative to the main body portion for retaining the medium therein;
a state detection portion for detecting a movement of the medium storage portion from the main body portion;
a medium characteristic identifying portion for identifying a characteristic feature of the medium in a middle of transportation of the medium;
a medium characteristic recording portion for recording information of the characteristic feature of the medium; and
a control portion for controlling an operation of the image forming apparatus according to the information of the characteristic feature of the medium,
wherein said control portion is configured to control the medium characteristic identifying portion to identify the characteristic feature of the medium and update the information of the characteristic feature of the medium recorded in the medium characteristic recording portion when a power source is changed from an off state to an on state and the state detection portion detects the movement of the medium storage portion from the main body portion.

2. The image forming apparatus according to claim 1, further comprising:
a medium moving portion for pressing the medium against a medium pickup member and for moving the medium and the medium pickup member toward the state detection portion when the power source is in the on state; and
a releasing portion for releasing the medium from the medium moving portion so that the medium is moved away from the state detection portion when the medium storage portion is detached from the main body portion,
wherein said state detection portion is configured to detect the medium pickup member or a member connected to the medium pickup member as a detection target so that the state detection portion detects that the medium storage portion is detached from the main body portion.

3. The image forming apparatus according to claim 2, wherein said releasing portion is configured to lower by own weight to release the medium when the medium storage portion is detached from the main body portion.

4. The image forming apparatus according to claim 2, further comprising a lifting portion for lifting the medium stored in the medium storage portion to abut against the medium pickup member, wherein said medium moving portion includes a drive source for driving the lifting portion.

5. The image forming apparatus according to claim 4, wherein said medium moving portion is configured to drive the lifting portion to lift the medium stored in the medium storage portion to abut against the medium pickup member so that the medium pickup member can picks up the medium from the medium storage portion to the image forming portion, and
said lifting portion is configured to move the medium pickup member toward the state detection portion while the medium is abutting against the medium pickup member.

6. The image forming apparatus according to claim 4, wherein said lifting portion includes a first gear to be driven by the medium moving portion to rotate; a second gear engaging with the first gear to move around the first gear; a gear teeth portion engaging the second gear; and a stage having a distal end portion to be moved along with the second gear,
said stage has the distal end portion to be moved when the medium moving portion is operated while the power source is being in the on state, and
said medium moving portion is configured to abut against the medium to be moved when the distal end portion of the stage is moved.

7. The image forming apparatus according to claim 1, wherein said medium characteristic identifying portion includes a medium thickness sensor for identifying a thickness of the medium as the characteristic feature of the medium.

8. The image forming apparatus according to claim 1, wherein said medium characteristic identifying portion includes a medium type sensor for identifying a type of the medium as the characteristic feature of the medium.

9. The image forming apparatus according to claim 1, further comprising a fixing portion for heating and pressing the medium so that the image is fixed to the medium,
wherein said control portion is configured to set a target temperature of the fixing portion according to the information of the characteristic feature of the medium stored in the medium characteristic recording portion.

10. The image forming apparatus according to claim 1, wherein said control portion is configured to control the medium characteristic recording portion to maintain the information of the characteristic feature of the medium before the power source becomes the off state when the power source is changed from the off state to the on state and the state detection portion does not detect that the medium storage portion is detached from the main body portion.

11. The image forming apparatus according to claim 2, further comprising a holding portion for holding the detection target at a position before the power source is turned off until the medium storage portion is detached from the main body portion even when the power source is in the off state.
